(19) United States
(12) Patent Application Publication
(10) Pub. No.: US 2025/0131017 A1
(43) Pub. Date: Apr. 24, 2025

(54) MACHINE TIME ESTIMATION FOR CONTINUOUS MAINTENANCE OF CLUSTERED DATA

(71) Applicant: Snowflake Inc., Bozeman, MT (US)

(72) Inventors: Varun Ganesh, San Bruno, CA (US); Kevin Ali Li, Burlingame, CA (US); Ryan Michael Thomas Shelly, San Francico, CA (US); Jiaqi Yan, Menlo Park, CA (US)

(21) Appl. No.: 18/917,533

(22) Filed: Oct. 16, 2024

Related U.S. Application Data
(60) Provisional application No. 63/591,992, filed on Oct. 20, 2023.

(51) Int. Cl. G06F 16/28

(52) U.S. Cl. CPC G06F 16/285

(57) ABSTRACT

A method includes sampling, by at least one hardware processor, a table using a clustering key to obtain a set of batches. Each batch of the set of batches includes a set of partitions of the table. A clustering job is performed for at least one batch of the set of batches. A machine processing cost associated with the clustering job is determined on a per-row basis. A total clustering cost associated with clustering data in the table is determined based on the machine processing cost on the per-row basis.

### PRIORITY CLAIM

This application claims the benefit of priority to the U.S. Provisional Patent Application 63/591,992, filed Oct. 20, 2023, and entitled “MACHINE TIME ESTIMATION FOR CONTINUOUS MAINTENANCE OF CLUSTERED DATA,” which application is incorporated herein by reference in its entirety.

### TECHNICAL FIELD

Embodiments of the disclosure generally relate to databases and, more specifically, to machine time estimation for continuous maintenance of clustered data (e.g., based on key and data manipulation language (DML) pattern).

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used for storing different types of content, such as bibliographic, full text, numeric, and image content. Further, in computing, different database systems may be classified according to the organizational approach of the database. There are many different types of databases, including relational databases, distributed databases, cloud databases, object-oriented databases, and others. Efficient management of databases, including clustering cost estimation, can be challenging and time-consuming.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a diagram illustrating the components of a compute service manager using a clustering cost estimation manager (CCEM), in accordance with some embodiments of the present disclosure.

FIG. 3 is a diagram illustrating components of an execution platform, in accordance with some embodiments of the present disclosure.

FIG. 4, FIG. 5, FIG. 6, and FIG. 7 illustrate examples of table clustering based on IDs, in accordance with some embodiments of the present disclosure.

FIG. 8 illustrates table partition selection and clustering flow, in accordance with some embodiments of the present disclosure.

FIG. 9 is a diagram illustrating file selection on DML history, in accordance with some embodiments of the present disclosure.

FIG. 10 is a diagram illustrating file selection on DML history to generate table version deltas, in accordance with some embodiments of the present disclosure.

FIG. 11 and FIG. 12 are diagrams illustrating file selection on files added between two DML versions, in accordance with some embodiments of the present disclosure.

FIG. 13 is a diagram illustrating an example cost estimation flow, in accordance with some embodiments of the present disclosure.

FIG. 14 illustrates an example maintenance cost formula that can be used with the disclosed techniques, in accordance with some embodiments of the present disclosure.

FIG. 15 is a diagram illustrating partition selection for reclustering, in accordance with some embodiments of the present disclosure.

FIG. 16 is a diagram of an example cost estimation verification flow, in accordance with some embodiments of the present disclosure.

FIG. 17, FIG. 18, and FIG. 19 illustrate respective example code for DML statement configuration, file selection, and clustering, in accordance with some embodiments of the present disclosure.

FIG. 20 is a graph illustrating the impact of a DML on clustering processing time, in accordance with some embodiments of the present disclosure.

FIG. 21 is a flow diagram illustrating the operations of a database system in performing a method for clustering cost estimation, in accordance with some embodiments of the present disclosure.

FIG. 22 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions or partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

In some aspects, one or more table columns/expressions can be designated as a clustering key for a table. A clustering key is a subset of columns in a table (or expressions on a table) that are explicitly designated to co-locate the data in the table in the same micro-partitions (or contiguous units of storage). A table with a clustering key can be considered to be clustered. Estimating clustering costs can be time-consuming as it depends on data distribution, data characteristics, and the DML pattern on the table. Analysis of linear correlations of general DML job properties to clustering indicates that no clear correlation exists and, as such, an accurate cost model can be challenging to obtain over variant data for generic keys without actual assessment of data layout on the table (i.e., a simple sizing of the table to cost and sizing of average DMLs to cost is not achievable).

As used herein, the term “cost” (e.g., for a data processing operation) indicates processing time associated with completing the data processing operation.

The disclosed techniques can be used to configure a clustering cost estimation manager (CCEM) to perform a method of one-time clustering cost estimation and maintenance cost estimation for clustering a table based on a user-defined key. More specifically, the disclosed techniques include modeling cost on sampled data from the table and generating a reasonable accuracy of cost for the majority of DML use cases by observing the pattern of DMLs on the table over some time. The proposed CCEM technique models maintenance cost based on actual sampled data from the table, looking at historical DML patterns to evaluate the rate of change on the table, considering windows of DML over which the aggregated cost of clustering will be similar, and modeling removal and reinsertion of data over the table. The disclosed techniques also determine one-time build costs by calculating the layout of data on the whole table, calculating the cost of the one-time sort, and determining write amplification that may happen from the service. In some aspects, the CCEM can be used in connection with an evaluation service that can continually run in the background, generate data on current tables, and verify cost estimation correctness.

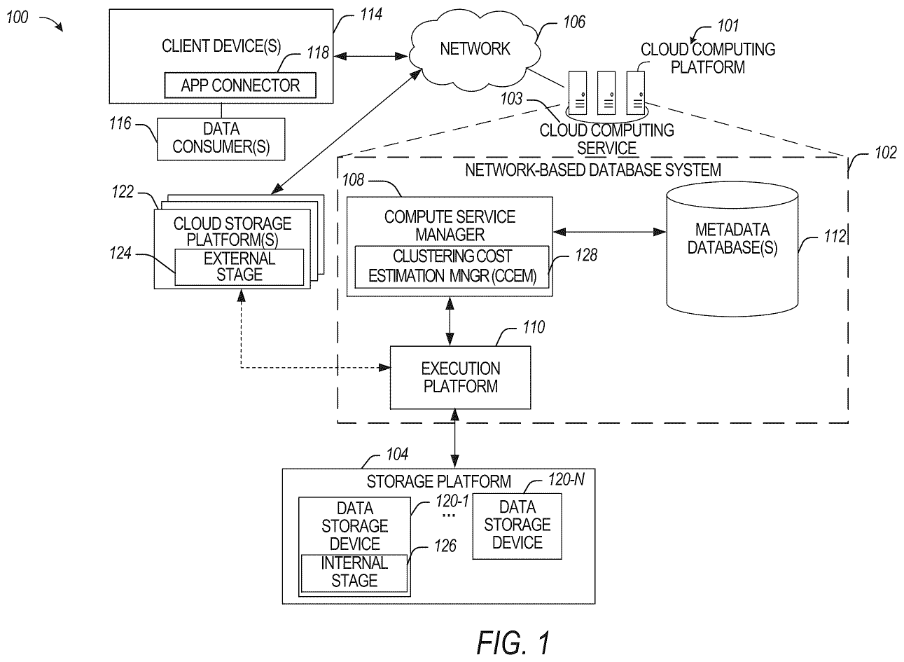

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102, storage platforms 104 and 122. The cloud computing platform 101 provides computing resources and storage resources that may be acquired (purchased) or leased (e.g., by users such as data providers and data consumers) and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the attribute store configuration functions described herein). The cloud computing platform 101 may include a three-tier architecture: data storage (e.g., storage platforms 104 and 122), an execution platform 110, and a compute service manager 108 providing cloud services (e.g., functionalities of the CCEM 128 to configure clustering cost estimation, clustering cost verification, and related processing).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and files of one or more other types—on, as examples, one or more of their servers and on one or more cloud-storage platforms such as AMAZON WEB SERVICES™ (AWS™), MICROSOFT® AZURE®, GOOGLE CLOUD PLATFORM™, and the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and external stages are stages that correspond to data storage at one or more external storage locations. In this regard, external files can be stored in external stages at one or more external storage locations. Internal files can be stored in internal stages at one or more internal storage locations, which can include servers managed and controlled by the same organization (e.g., company) that manages and controls the data platform, and which can instead or in addition include data storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the storage platforms 104 and 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the storage platform 104. The storage platform 104 comprises a plurality of computing machines and provides on-demand computer system resources such as data storage and computing power to the network-based database system 102.

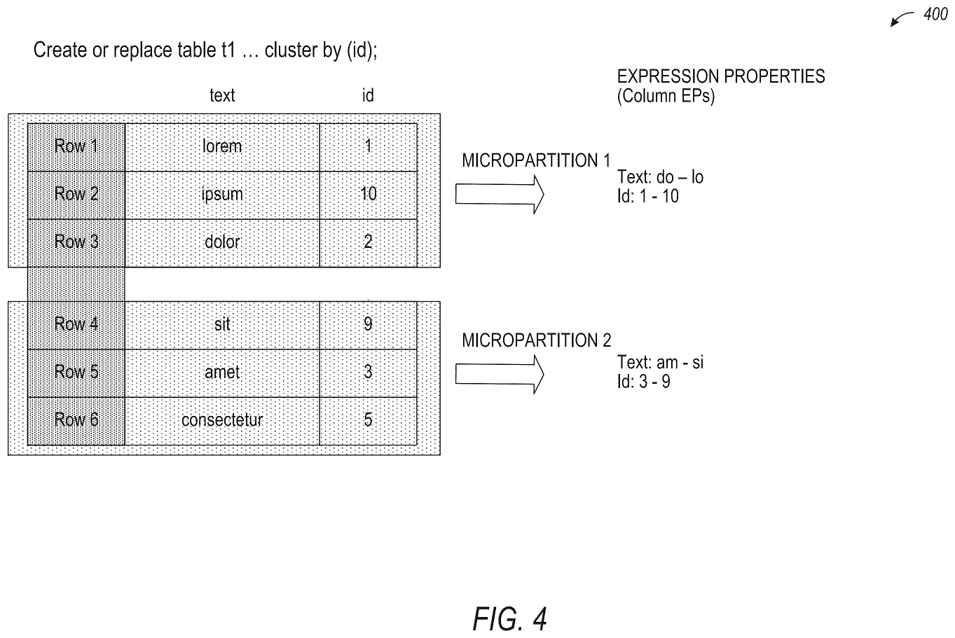

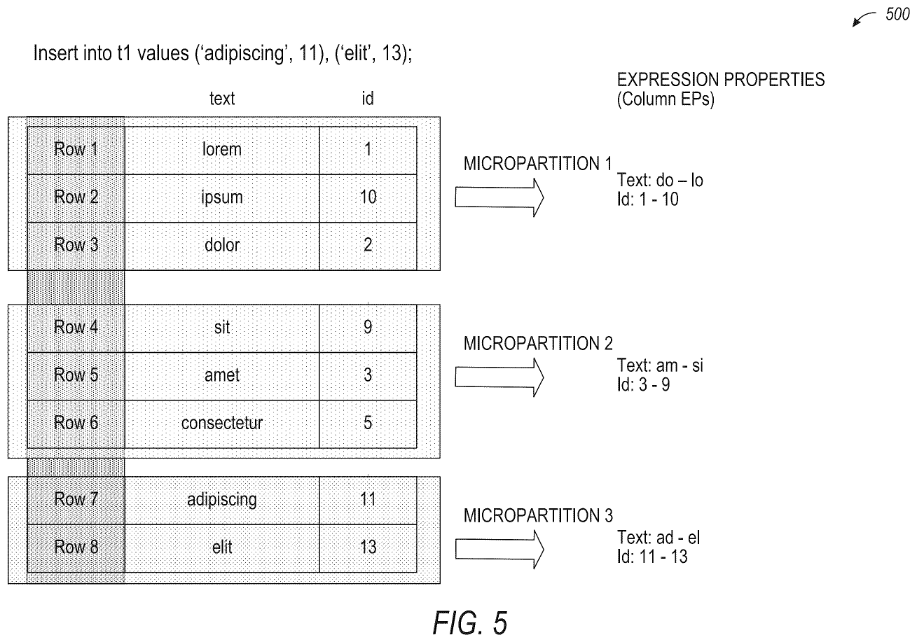

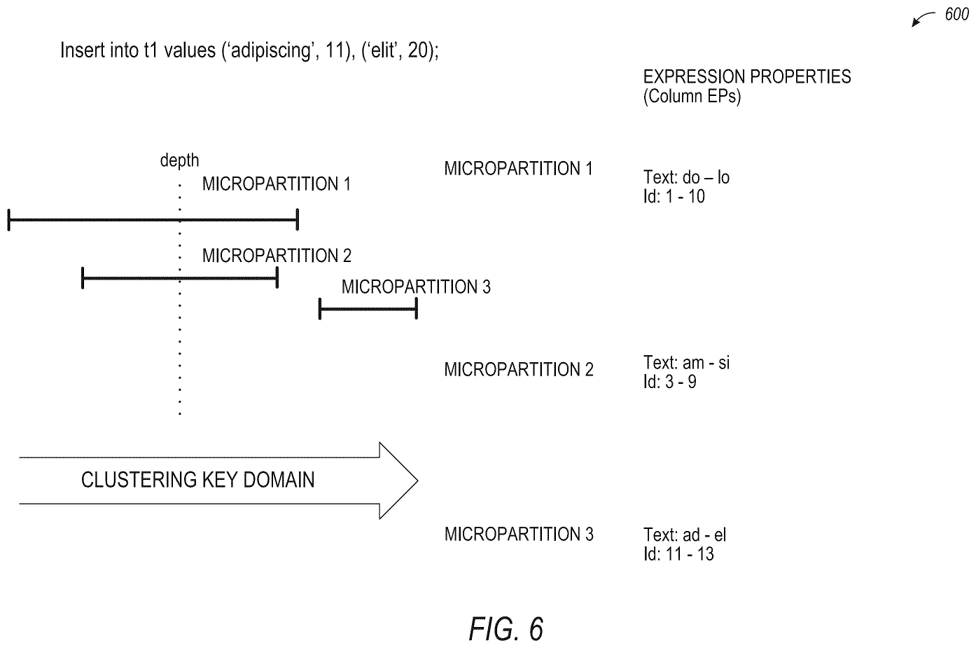

The network-based database system 102 comprises a compute service manager 108, an execution platform 110, and one or more metadata databases 112. The network-based database system 102 hosts and provides data reporting and analysis services (as well as additional services such as the disclosed clustering cost estimation and clustering cost verification functions performed by CCEM 128) to multiple client accounts, including an account of the data provider associated with client device 114 and an account of the data consumer 116. In some embodiments, the compute service manager 108 comprises the CCEM 128, which can be used in connection with configuring and implementing the disclosed clustering cost estimation and clustering cost verification functions. A more detailed description of the functions provided by the CCEM 128 is provided in connection with FIGS. 4-21.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider or another type of user) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed clustering cost estimation and clustering cost verification functions).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client devices (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., disclosed clustering cost estimation and clustering cost verification functions) offered by the network-based database system 102 via network 106.

The compute service manager 108 is also coupled to one or more metadata databases 112 that store metadata about various functions and aspects associated with the network-based database system 102 and its users. For example, a metadata database of the one or more metadata databases 112 may include a summary of data stored in remote data storage systems as well as data available from a local cache. Additionally, a metadata database of the one or more metadata databases 112 may include information regarding how data is organized in remote data storage systems (e.g., the storage platform 104) and the local caches. Information stored by a metadata database of the one or more metadata databases 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platforms 104 and 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the storage platforms 122.

In some embodiments, communication links between elements of the computing environment 100 are implemented via one or more data communication networks, such as network 106. The one or more data communication networks may utilize any communication protocol and any communication medium. In some embodiments, the data communication networks are a combination of two or more data communication networks (or sub-networks) coupled with one another. In alternate embodiments, these communication links are implemented using any communication medium and any communication protocol.

The compute service manager 108, the one or more metadata databases 112, the execution platform 110, and the storage platform 104 are shown in FIG. 1 as individual discrete components. However, each of the compute service manager 108, one or more metadata databases 112, execution platform 110, and storage platforms 104 and 122 may be implemented as a distributed system (e.g., distributed across multiple systems/platforms at multiple geographic locations). Additionally, each of the compute service manager 108, one or more metadata databases 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database of the one or more metadata databases 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the storage platform 104. Thus, the computing resources and cache resources are not restricted to specific data storage devices 120-1 to 120-N. Instead, all computing resources and all cache resources may retrieve data from and store data to any of the data storage resources in the storage platform 104.

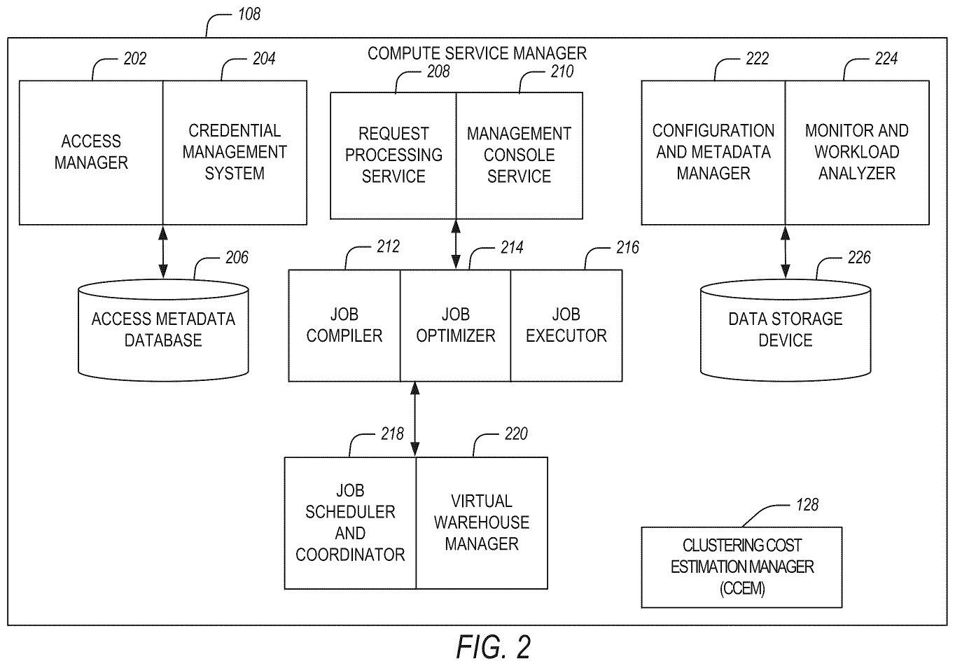

FIG. 2 is a block diagram illustrating components of the compute service manager 108 using a CCEM, in accordance with some embodiments of the present disclosure. As shown in FIG. 2, the compute service manager 108 includes an access manager 202 and a credential management system 204 coupled to an access metadata database 206, which is an example of the one or more metadata databases 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs, such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in the execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

In some embodiments, the compute service manager 108 further includes the CCEM 128, which can be used in connection with the disclosed clustering cost estimation and clustering cost verification functions.

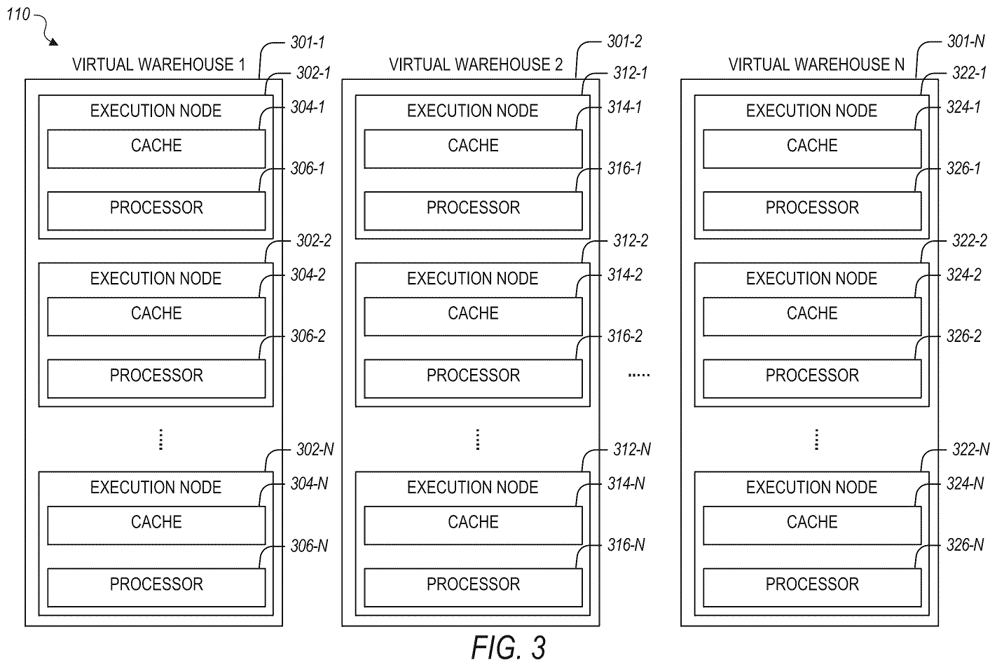

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, they can access data from any of the data storage devices 120-1 to 120-N within the storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes: 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while another computing system implements virtual warehouses 2 and N at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and caching resources are needed. Similarly, existing virtual warehouses may be deleted when the resources associated with the virtual warehouse are no longer necessary.

In some embodiments, the virtual warehouses may operate on the same data in the storage platform 104, but each virtual warehouse has its execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

As used herein, the term “maintenance cost” indicates the cost to maintain a well-clustered state given a stationary DML pattern on a table. As used herein, the term “initial cost” indicates the cost to initially get to a well-clustered state, given the current state of the table for a given key.

In some aspects, CCEM 128 is configured to perform static cost analysis, i.e., estimating the cost of clustering at a point in time given historical data. In some aspects, CCEM 128 is configured to also perform continuous and dynamic cost estimation for an ongoing clustered table that is maintained at a clustered state.

In some aspects, CCEM 128 can consider the following configurations when estimating clustering cost:
(a) Existing clustering keys where an estimation is needed for ongoing clustering state maintenance based on table mutations; and
(b) Estimation of cost to reach a clustered state for a different key suggestion based on current state and historical DMLs.

In some aspects, the first configuration (a) can be viewed as an enhancement of the second configuration (b), where users have a continuous way of maintaining expectations on their existing clustered table.

The second configuration (b) is static analysis on the table given a key suggestion and can be viewed as a point-in-time computation. In some aspects, the two separate inputs to consider when estimating clustering credit costs are the cost to achieve a well-clustered state given a current state and key and the cost to maintain a well-clustered state given expected DMLs on the table. Both of these can be achieved through static point-in-time analysis.

In some aspects, CCEM 128 is configured to perform cost estimation using the following two techniques:
(a) Static (one-time clustering) cost analysis: Given a key and the current state of the table, CCEM 128 determines what is the cost to re-cluster the table to a converged state. In some aspects, this cost can be estimated by estimating the cost of clustering the entire table (assuming the data can be sorted exactly once by needing N resources, then converting this cost when the current clustering algorithm is used by accounting for the additional write amplification).
(b) Ongoing maintenance cost analysis: Given the history of DMLs on the table, CCEM 128 determines what can be expected as the maintenance cost on the table. This is a forecasting problem and can be dependent on historical DMLs on an existing table.

FIG. 4, FIG. 5, FIG. 6, and FIG. 7 illustrate corresponding diagrams 400, 500, 600, and 700 of table clustering based on IDs, in accordance with some embodiments of the present disclosure.

Referring to FIG. 4, diagram 400 illustrates clustering micropartitionn 1 based on values 1-10 in the ID column, and clustering micropartition 2 based on values 3-9 in the ID column of the table.

Referring to FIG. 5, diagram 500 illustrates inserting new rows 7 and 8 as micropartition 3 and clustering micropartition 3 based on values 11-13 in the ID column.

Referring to FIG. 6, diagram 600 illustrates clustering depth in relation to the clustering key domain. As seen in diagram 600, clustering based on ID 3-9 in micropartition 2 overlaps with clustering based on ID 1-10 in micropartition 1. However, clustering based on ID 11-13 in micropartition 3 does not overlap with the clustering in micropartitions 1 and 2.

Referring to FIG. 7, diagram 700 illustrates reclustering of micropartitions 1, 2, and 3 so that there is no data overlap between partitions. As seen in diagram 700, clustering of the 3 micropartitions results in IDs 1-3 being in micropartition 1, IDs 6-10 being in micropartition 2, and IDs 11-13 being in micropartition 3, which is a more efficient clustering of the table as overlap in IDs between partitions is avoided.

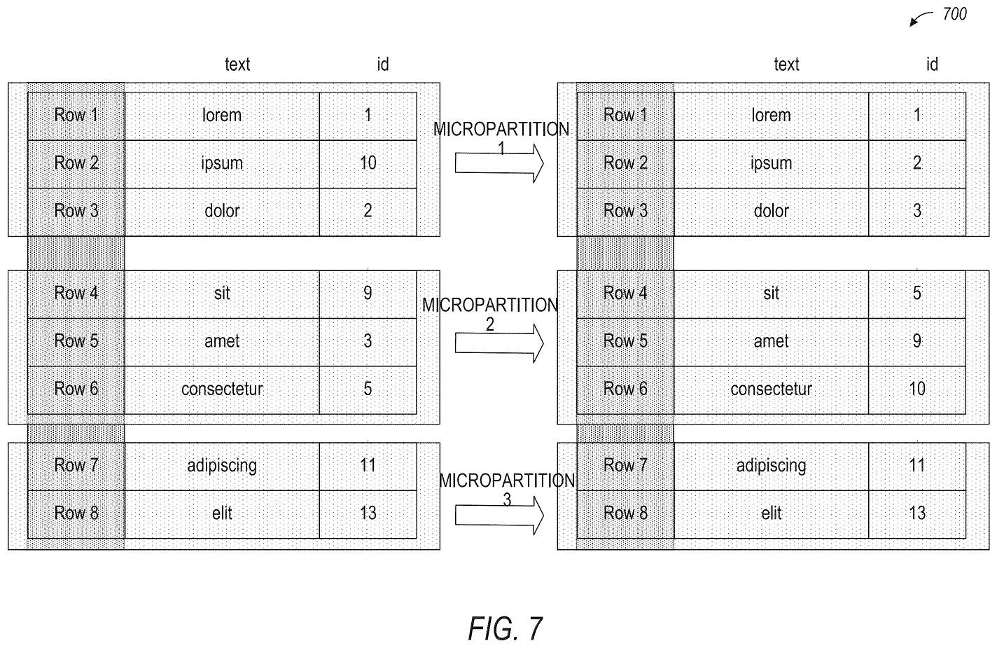

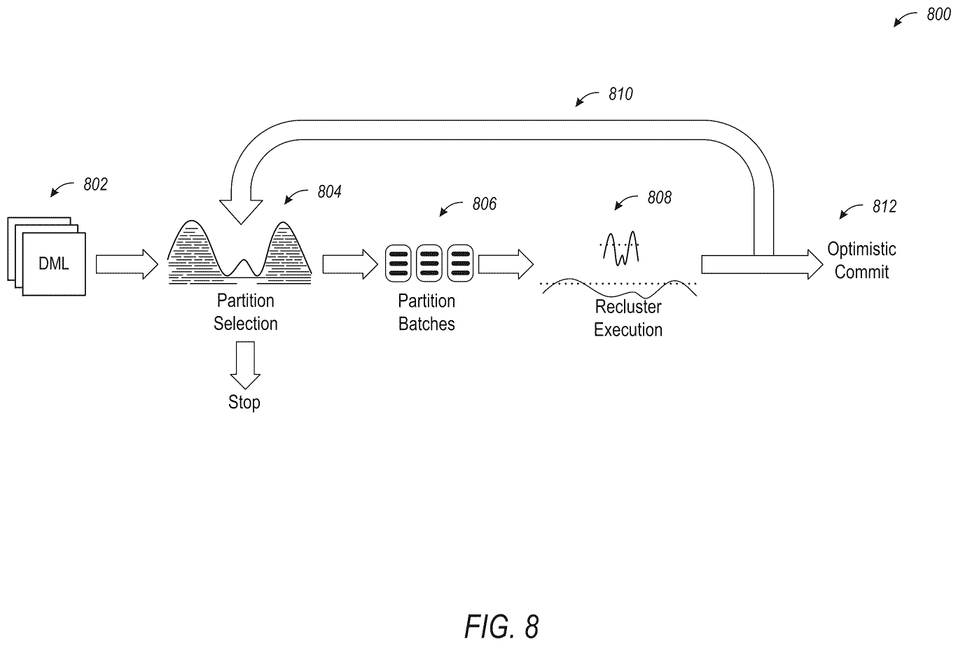

FIG. 8 illustrates diagram 800 of a table partition selection and clustering flow, in accordance with some embodiments of the present disclosure. Referring to FIG. 8, at operation 802, a new DML triggers partition selection. At operation 804, partition selection is decoupled from execution. At operation 806, work is divided into batches. At operation 808, execution is reclustered. At operation 810, reclustering is repeated until the table is well-clustered (e.g., clustered to achieve a threshold clustering level). At operation 812, an optimistic commit is performed.

In some aspects, the cost per row per table has a linear correlation for sorting on a particular key. The CCEM 128 can generate regular file selection on a table to get batches and schedule an asynchronous batch job on N batches. The CCEM 128 can extract average and maximum job statistics and determine per-row machine cost.

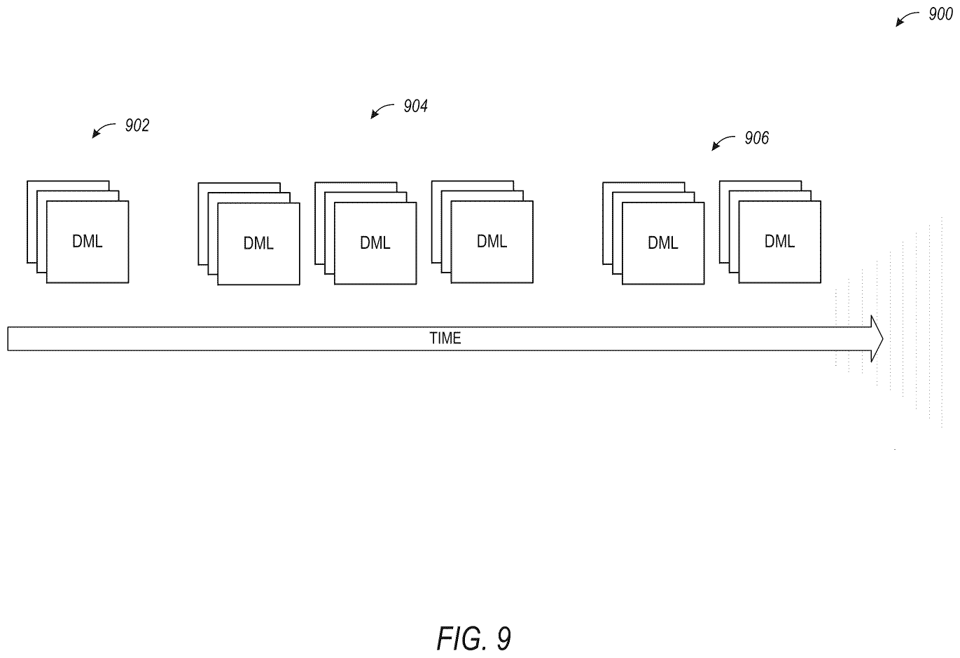

FIG. 9 is a diagram 900 illustrating file selection on DML history, in accordance with some embodiments of the present disclosure. FIG. 9 illustrates the initial state of tables 902, tables 904, and tables 906 based on DMLs applied over time.

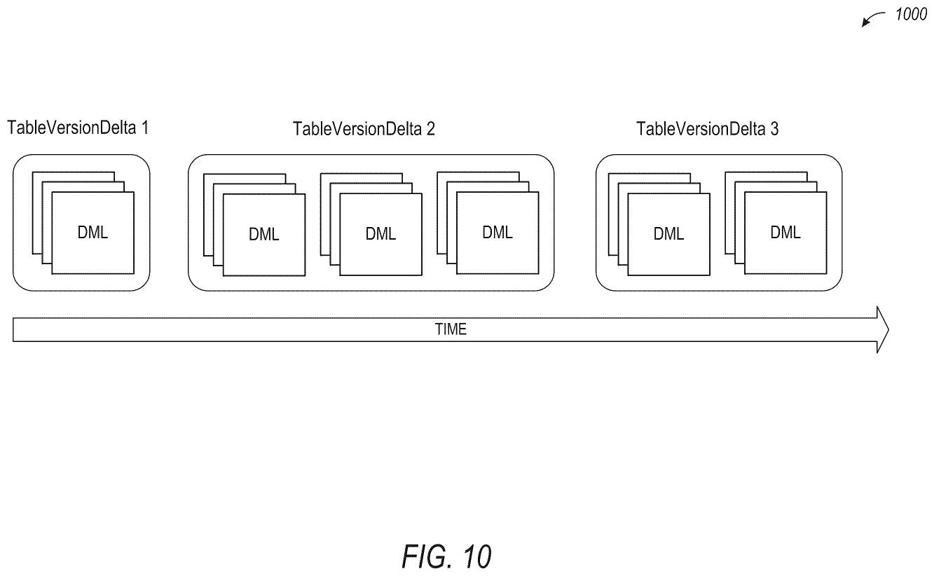

FIG. 10 is a diagram 1000 illustrating file selection on DML history to generate table version deltas, in accordance with some embodiments of the present disclosure. Referring to FIG. 10, diagram 1000 illustrates table version deltas (e.g., Table VersionDelta1, Table VersionDelta2, and Table VersionDelta3) associated with the application of DMLs on tables 902, tables 904, and tables 906.

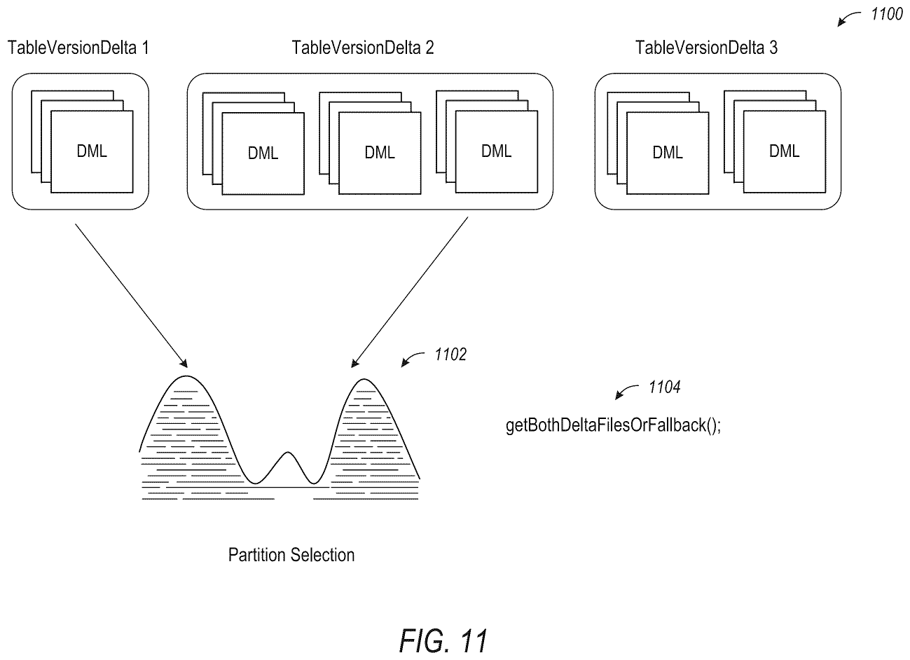

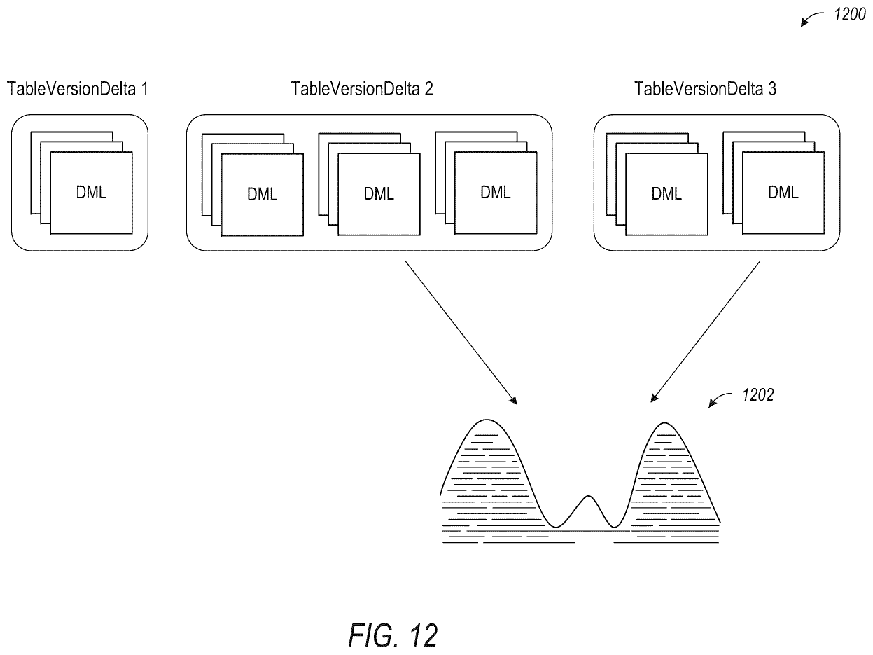

FIG. 11 and FIG. 12 are corresponding diagrams 1100 and 1200 illustrating file selection on files added between two DML versions, in accordance with some embodiments of the present disclosure. Referring to FIG. 11, command 1104 can be used to obtain partition selection 1102 on files added between Table VersionDelta1 and Table VersionDelta2. Referring to FIG. 12, command 1104 can be used to obtain partition selection 1202 on files added between Table VersionDelta2 and Table VersionDelta3.

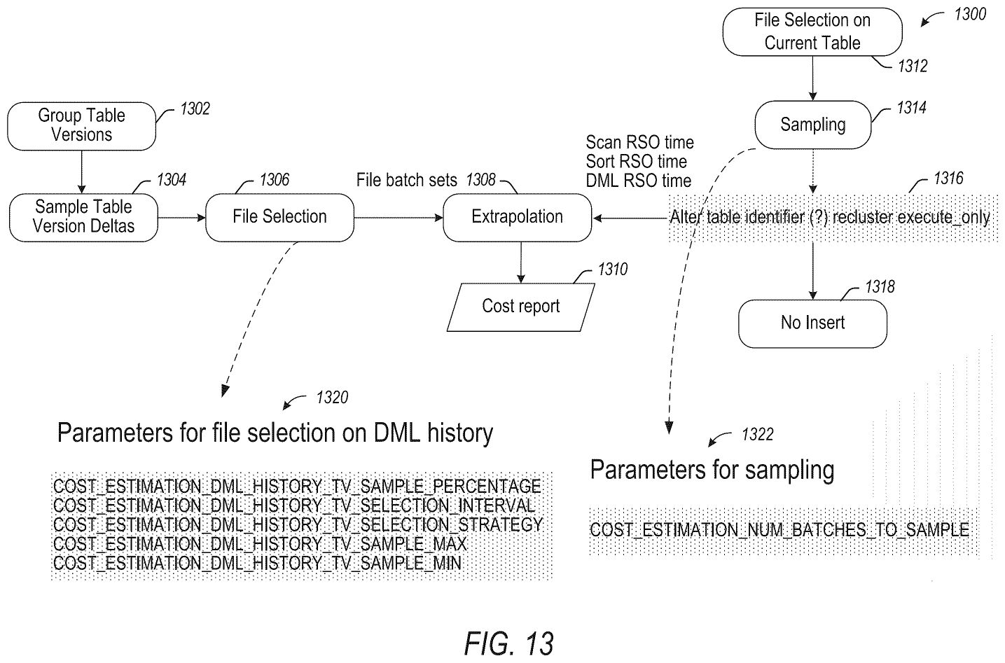

FIG. 13 is a diagram 1300 illustrating an example cost estimation flow, in accordance with some embodiments of the present disclosure. Referring to FIG. 13, the cost estimation flow can start at operation 1302, when table versions are grouped. At operation 1304, table version deltas are sampled using the grouped table versions. At operation 1306, file selection is performed on the DML history. In some aspects, parameters 1320 can be used to perform the file selection.

At operation 1312, file selection is performed on a current table. At operation 1314 sampling is performed on the current table. In some aspects, parameters 1322 can be used for the sampling. At operation 1316, reclustering is executed without performing data insertion (at operation 1318). At operation 1308, extrapolation is performed based on the file selection at operation 1306 and sampling at operation 1314.

In some aspects, and as illustrated in FIG. 9 and FIG. 10, temporally co-located DMLs can be grouped and viewed as a single DML for purposes of clustering cost determination. In some aspects, CCEM 128 is configured to perform DML grouping in a meaningful time window and use table version boundaries to determine expression properties (EPs). In some aspects, CCEM 128 samples meaningful groups, performs file selection on those deltas alone and adds them to obtain a total cost across DMLs. In some aspects, sets of overlaps within that static data set are analyzed, the cost of sorting each set of overlapping data is determined, and then the resulting costs are added for a total cost determination.

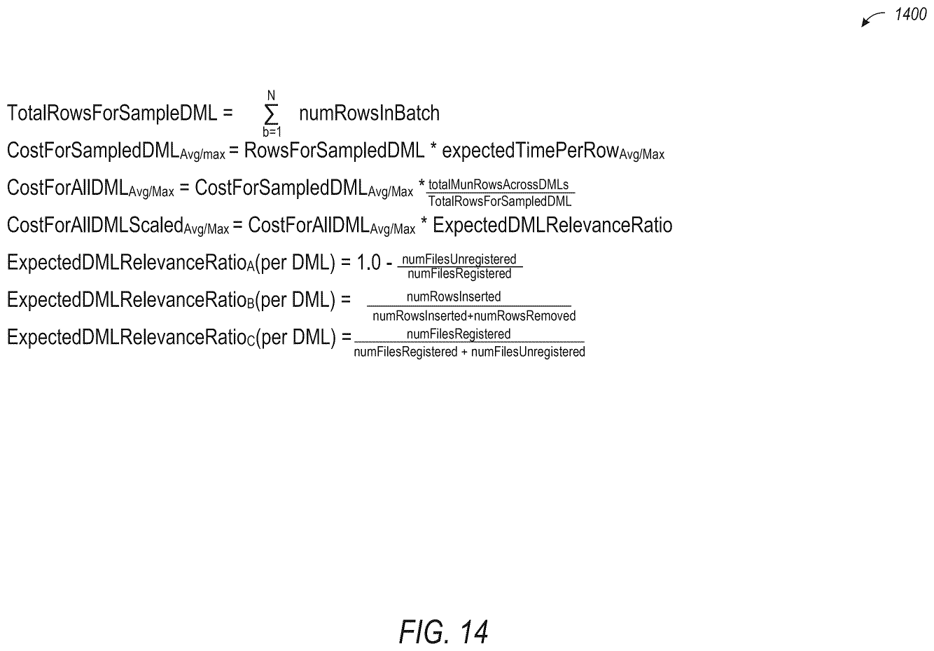

FIG. 14 illustrates an example maintenance cost formula 1400 that can be used with the disclosed techniques, in accordance with some embodiments of the present disclosure.

In some aspects, CCEM 128 can ignore table versions that do not include any inserts in a sample. In some aspects, CCEM 128 can perform weighting by rows for extrapolation of versions that were not sampled. In some aspects, CCEM 128 can consider newly added files into an already clustered table and ignore existing overlaps.

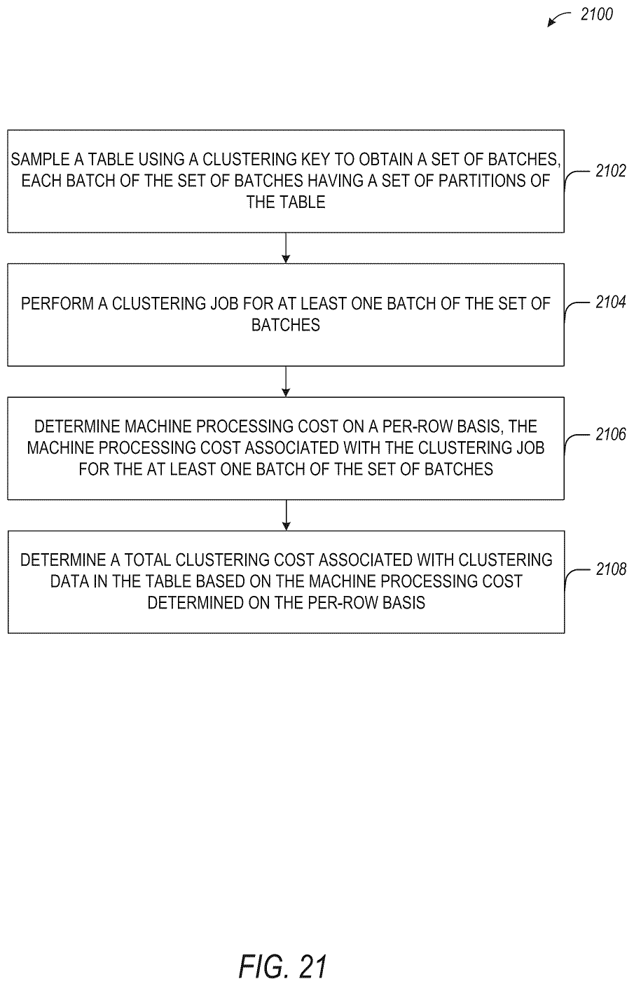

In some aspects, CCEM 128 can perform clustering cost estimation based on the following functionalities (also illustrated in FIG. 21);
(a) Sample a table using a clustering key to obtain a set of batches, each batch of the set of batches having a set of partitions of the table.
(b) Perform a clustering job for each batch of the set of batches.
(c) Determine machine processing cost on a per-row basis for each batch of the set of batches.
(d) Determine maintenance cost and initial cost associated with clustering data in the table based on the determined machine processing cost on a per-row basis.

Step (d) can include one or more of the following functions:
(e) Perform grouping of the table DMLs to obtain table deltas.
(f) Perform a file selection on each of the table deltas.
(g) Determine the number of rows in each table delta.
(h) Determine the total clustering cost based on the number of rows and the determined machine processing cost on a per-row basis.

In some aspects, the formulas illustrated in FIG. 14 can be applied to obtain the correlation cost. In some aspects, the cost of all DMLs can be adjusted based on optimizations associated with a clustered table, which are reflected by the parameter ExpectedDMLRelevanceRatio in FIG. 14. This parameter can be a measure of introduced new data by the DMLs as opposed to old data being reinserted during clustering.

The following functionalities can be performed for static (one-time clustering) cost analysis. To obtain an estimation of cost, CCEM 128 can estimate the lower bound for sorting a range of data. It is possible to estimate using a file selection algorithm by adding a few assumptions, as described herein below.

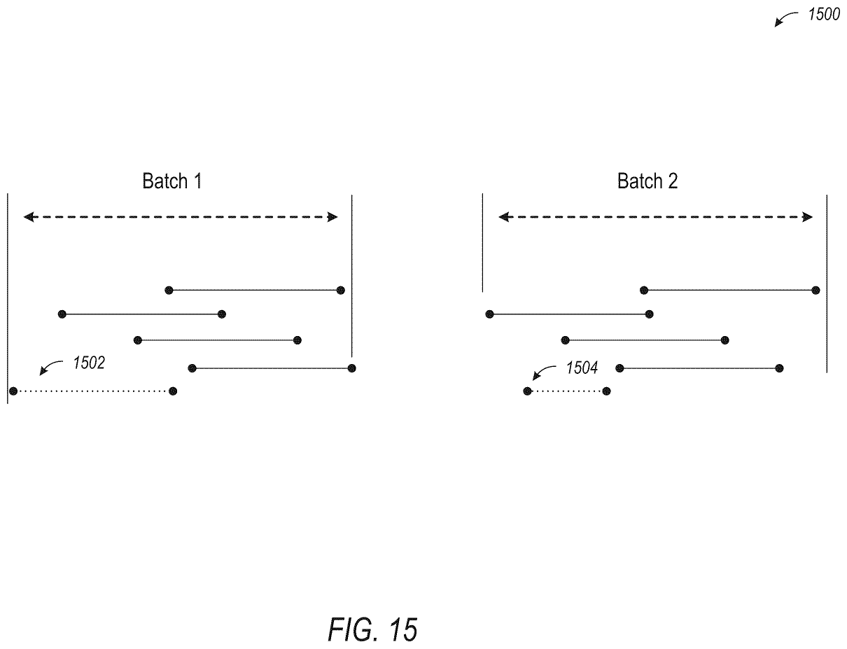

FIG. 15 is a diagram 1500 illustrating partition selection for reclustering, in accordance with some embodiments of the present disclosure.

In some aspects, the following convergence lemma can be used with the disclosed techniques. If a partition (e.g., partition 1502 or partition 1504 in FIG. 15) is not selected for reclustering given a set of overlaps, then after surrounding partitions are re-clustered, the depth of the partition not selected either improves or remains the same but does not become worse.

In some aspects, the following boundary lemma can be used with the disclosed techniques. If a given batch of partitions does not overlap any other batch of partitions, then the cost of clustering that batch can be estimated separately from the other batches. For example, batch 1 and batch 2 in FIG. 15 can be estimated for cost separately.

In some aspects, the static (one-time clustering) cost analysis can be based on one or more of the following functionalities.

### (a) Identifying File Batches to Sort.

To obtain a lower bound cost to cluster a table, the CCEM 128 can parse the partition EPs based on the clustering key and separate groups of overlapping partitions into separate batches. In some aspects, only partitions whose depths are greater than the clustering threshold can be counted towards the batch as per the convergence lemma above.

### (b) Estimating the Cost of Sorting a Batch.

A single clustering execution job incurs costs from TableScan, Insert, and Sort operations. Of these, there are two distinct observable behaviors.

(b.1) When the partition file size is close to an uncompressed file size, data for the estimated batch size fits mostly in memory. In this case, time is nominally split between operators, and in some cases, a sort operation cost may become amortized. In some aspects, the cost of insert and tablescan operations can depend on the cost of compression, which in turn depends on the datatypes of columns and the total number of columns. In some aspects, linear regression analysis can be used to corroborate this finding. Thus, the cost of an insert operation can be estimated based on the expected cost of compression for data.

(b.2) When partitions are well compressed such that uncompressing them results in spillage for a SORT operation on a single machine. In this case, external merge sort causes sort to factor into the total time, and the total time taken can be dominated by an insert operation performing compression.

(b.3) Benchmarking per operator cost.

Because the cost of an insert operation mainly depends on compression which in turn depends on the number of columns, the expected time for insert may be obtained through linear regression as follows:

$$expected time for insert = a . x + b ,$$

$$where a = correlation from number of columns ,$$

$$x = number of rows ,$$

$$b = intercept ( static across training ) ,$$

$$and a = ( number of columns ) * ( datatype encoding constant ) .$$

In some aspects, the intercept value and datatype encoding constant are dependent on the data type (e.g., “datatype”) and number of columns, and can be obtained through benchmarking column types on a single instance warehouse.

In some aspects, a similar training model may be implemented for a TableScan operation. For a single machine sort, the cost of sorting in memory can be estimated as T(N)=w*N*lg(N), where N=the number of rows to sort, w=avg width of the sort key, and T(N) is the time complexity. Under benchmarking, if the cost of sorting a known value of k rows across a known width of the clustering sort key Wk can be estimated, then Expected sort time ts=(w*N*lg(N)*(benchmark time to sort k))/(wk*k*lg(k)). Spilling to disk and the number of merges for an external sort can be an added cost.

### (c) Estimating the Write Amplification for One Batch.

In some aspects, the estimating of the write amplification for one batch can be based on the following formula: log(total batch size/file size)/log(batch size multiplier), where:
(c.1) “file size” is an optimal file size for the table (e.g., 16 MB by default).
(c.2) “batch size multiplier” refers to how many “file size” files can fit into a single machine worker. For example, if the batch size multiplier is 16 and the file size is 16 MB, then the maximum batch size is 256 MB (16×16 MB).
(c.3) “total batch size” is the total batch size of the batch of files that are too large to fit into a single machine.

The next step for static analysis is to extend the results of (a) above to accommodate for the write amplification of the clustering algorithm. This is mainly due to the fact that all files in the batch from the previous step cannot fit in a single machine, in which case it will break down into sorting repeatedly across multiple levels. This is a factor of the NDV of the underlying columns in the clustering key.

In some aspects, the one-time cost per batch is defined as follows:

$${OneTimeCostPerBatch}_{Avg / Max} {t}_{s} = {expectedTimePerRow}_{avg / ma x} * numRowsInBatch$$

The write amplification on a batch can be defined as follows. If the number of partitions from the batch in step (a) is N and the number of partitions that can fit in a single machine is M, then write amplification, in some cases, can be determined based on the following formula: Write amplification α=lg(2, N/M)*(Ratio from NDV estimate) and Expected sort time for batch t\grave{ } s=α*ts. The assumption here is that the worst write amplification for a given batch of data is that one subset of the overlaps is processed as processing moves up the LSM tree, and the same data log times can be used. In other aspects, a different write amplification formula can be used as well.

### (d) Getting the Total One-Time Cost.

The total cost for one-time clustering given a key at any given point can be a summation of cost across all the batches estimated from above.

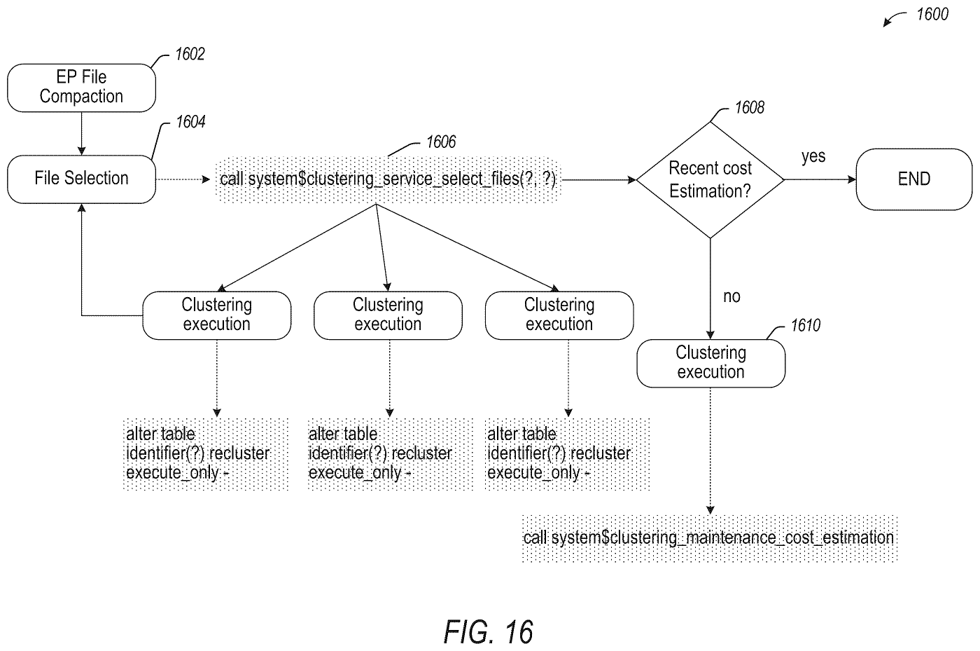

FIG. 16 is diagram 1600 of an example cost estimation verification flow, in accordance with some embodiments of the present disclosure. Referring to FIG. 16, at operation 1602, EP file compaction is performed. At operation 1604, file selection is performed. At operation 1606, clustering execution is performed. At operation 1608, a determination is made on whether a recent clustering cost estimation has been performed. If it has not been performed, at operation 1610, a clustering execution is performed. If a recent cost estimation has been performed (e.g., within a pre-configured period), the processing flow may end.

In some aspects, the following configurations can be used for cost estimation based on DML statistics. For example, the following feature set that is available for unclustered tables can be used to predict time spent reclustering: average time difference between DMLs (for example ms), average number of rows registered per DML, average file size per DML (bytes), average number of files registered per DML, number of columns, number of sub-columns, and NDV/clustering key cardinality.

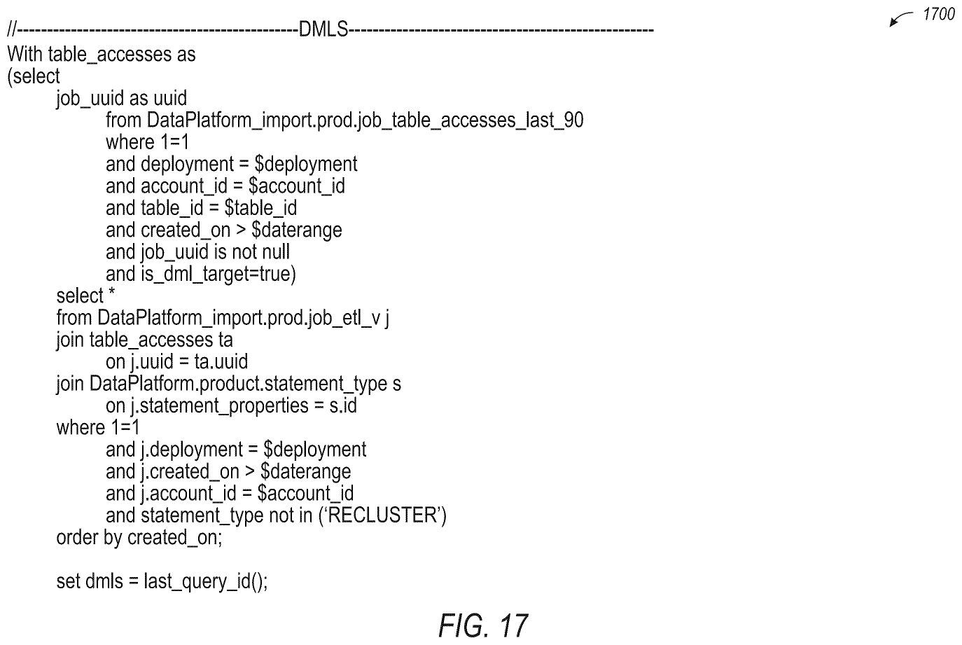

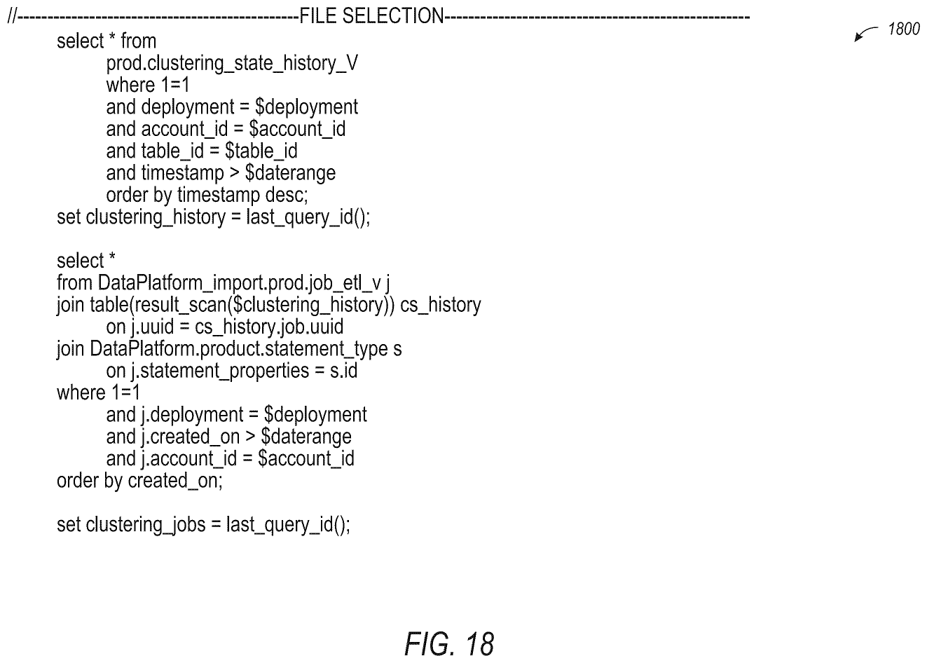

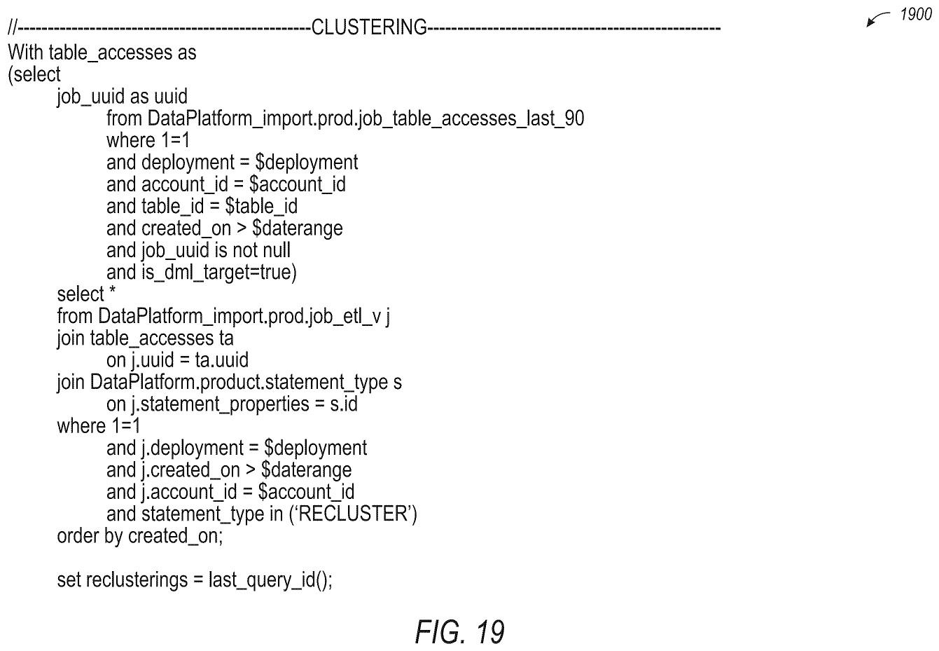

In some aspects, CCEM 128 can generate estimations based on DML churn. For example, CCEM 128 can examine clustered tables and draw correlations between files registered and time spent processing on an execution platform. In some aspects, CCEM 128 can use the example code in FIGS. 17-19 to perform the correlations.

FIG. 17, FIG. 18, and FIG. 19 illustrate respective diagrams 1700, 1800, and 1900 of example code for corresponding DML statement configuration, file selection, and clustering, in accordance with some embodiments of the present disclosure.

In some aspects, maintenance cost forecasting can be performed based on the following configurations. In some aspects, CCEM 128 can perform forecasting using statistical analysis of DML patterns.

In some aspects, ongoing DML maintenance costs can be forecasted based on historical DML on the table. This cost can further be imagined in terms of the number of partitions to recluster after each DML.

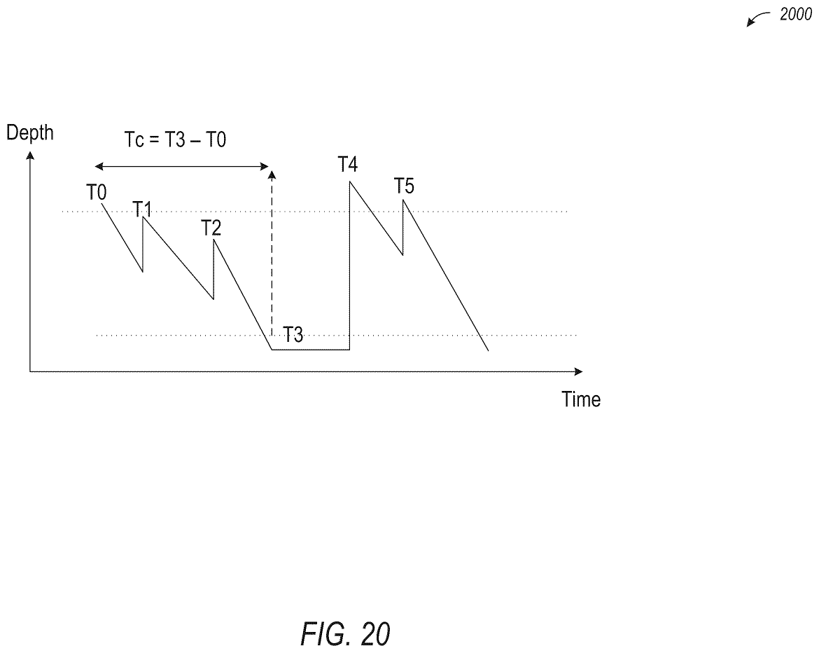

FIG. 20 is a graph 2000 illustrating the impact of a DML on clustering processing time, in accordance with some embodiments of the present disclosure.

In graph 2000, at each time T (except for T3), assume that DML occurs on a clustered table. Times T1 and T2 occur before the table can be well clustered following time T0. The following conclusions may be drawn:
(a) Times T4 and T0-T2 are fully independent in terms of maintenance cost as they are entirely separate.
(b) Time Tc is the time to cluster DMLs at T0, T1, and T2, and this is directly proportional to the number of files registered from times T0, T1, and T2 combined. This linear regression can be verified from existing tables with clustering by performing the same analysis mentioned above.

In some aspects, maintenance cost forecasting can be performed based on EP sampling for delta EPs from DMLs to obtain the average churn of depth produced by that DML.

In some aspects, the forecasting via statistical analysis makes a number of assumptions on the expected churn produced by the DML. An alternative approach is to extract delta EPs from each DML of high impact and then inspect the depth contained within those delta EPs. This, combined with an expected depth on the table at the point of DML, can assist in determining the number of batches that may be introduced by that one DML.

When walking through the table version history, characteristics of the table version can be derived, such as the number of files/partitions updated/deleted/added. Once table versions of high impact are identified, then the delta EPs introduced from that table version may be used to derive the depth contained within the files for that particular DML.

In some aspects, the number of partitions to be clustered after that DML is a factor of the number of partitions from that DML E (DML) with a high depth and the number of partitions expected to be clustered from the table at that point E (T). E (T) can be determined through the factors mentioned above in connection with the forecasting via a statistical analysis approach. In this regard, the problem is simplified as follows:
(a) Cost of sorting a batch as per the static cost analysis based on DML EP sampling; and
(b) Estimating the average cost per DML and then summing across all DMLs in the expected time period.

In both one-time analysis as well as maintenance cost forecasting, the time to sort can be guessed based on expected data characteristics. This, however, may not be accurate unless obtained by sampling. There are two separate sampling problems that CCEM 128 can be configured to resolve:
(a) Sampling to obtain the NDV of columns of the clustering key when it is not clearly known. This may be needed to estimate the write amplification factor for the sorting algorithm.
(b) Sampling to know the sort time that is to be expected for a batch of data. This may vary and cause an impact on insert and sorting costs, potentially due to disk spill and compression.

Sampling for both these problems can be different. For the first problem (a), table scan block sampling on the clustering columns can yield the expected NDV on the data. For the second problem (b), sampling can be based on performing clustering execution on a batch of data that is determined from file selection to obtain the characteristics of that data.

In some embodiments, CCEM 128 can be configured to perform clustering cost estimation verification. Some aspects of estimation verification are illustrated in FIG. 16.

In order to verify the correctness of cost estimations, an ongoing service may be configured to run/persist estimations and their last run timestamps.

Once online, both one-time and maintenance estimations can be continuously monitored for accuracy and effectiveness. This processing can be used to manage expectations around cost estimation accuracy. In some aspects, the estimations can be benchmarked on existing clustered tables, which provide the expected values (e.g., number of files to recluster, clustering credits, and other information obtainable from a clustering state history view and metadata) to serve as a point of comparison for the estimations.

In some aspects, estimations can be persisted and exported for validation. For maintenance cost estimation, the estimation function can be run on a consistent interval. The last run timestamp can be persisted along with the cost estimation. For one-time cost estimation, the estimation function can be run when the depth is high.

In some aspects, a framework of the compute service manager 108 is used to schedule tasks that run the maintenance estimation periodically.

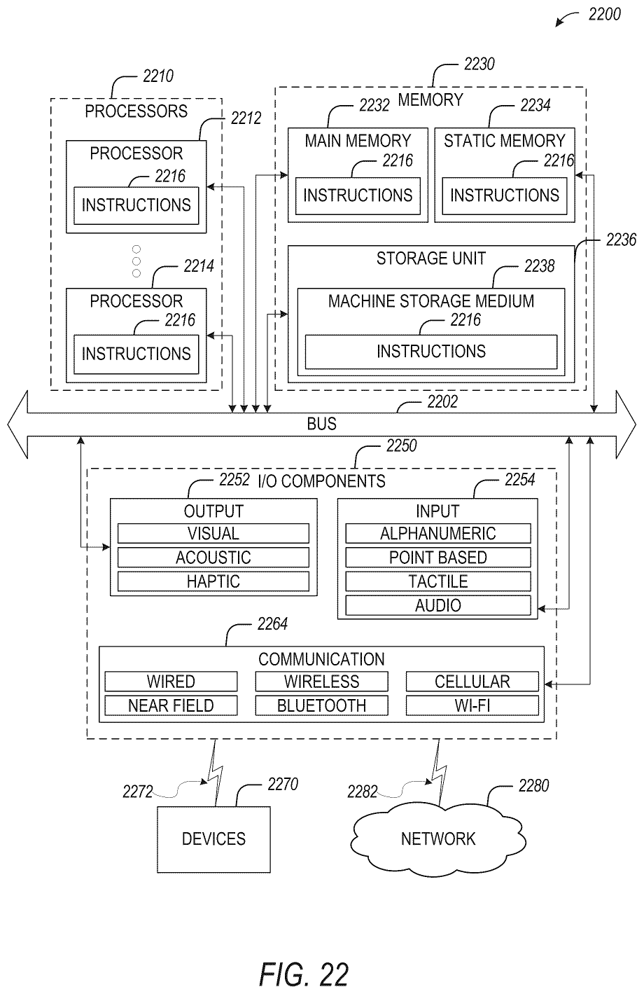

FIG. 21 is a flow diagram illustrating the operations of a database system in performing method 2100 for clustering cost estimation, in accordance with some embodiments of the present disclosure. Method 2100 may be embodied in computer-readable instructions for execution by one or more hardware components (e.g., one or more processors) such that the operations of method 2100 may be performed by components of network-based database system 102, such as components of the compute service manager 108 (e.g., the CCEM 128) and the execution platform 110 (which components may be implemented as machine 2200 of FIG. 22). Accordingly, method 2100 is described below, by way of example with reference to it. However, it shall be appreciated that method 2100 may be deployed on various other hardware configurations and is not intended to be limited to deployment within the network-based database system 102.

At operation 2102, CCEM 128 samples a table using a clustering key to obtain a set of batches. Each batch of the set of batches includes a set of partitions of the table.

At operation 2104, CCEM 128 performs a clustering job for at least one batch of the set of batches.

At operation 2106, CCEM 128 determines machine processing cost on a per-row basis. The machine processing cost is associated with the clustering job for the at least one batch of the set of batches.

At operation 2108, CCEM 128 determines a total clustering cost associated with clustering data in the table based on the machine processing cost on the per-row basis.

FIG. 22 illustrates a diagrammatic representation of machine 2200 in the form of a computer system within which a set of instructions may be executed for causing machine 2200 to perform any one or more of the methodologies discussed herein, according to an example embodiment. Specifically, FIG. 22 shows a diagrammatic representation of machine 2200 in the example form of a computer system, within which instructions 2216 (e.g., software, a program, an application, an applet, an app, or other executable code) for causing the machine 2200 to perform any one or more of the methodologies discussed herein may be executed. For example, instructions 2216 may cause machine 2200 to execute any one or more operations of method 2100 (or any other technique discussed herein, for example, in connection with FIG. 4-FIG. 21). As another example, instructions 2216 may cause machine 2200 to implement one or more portions of the functionalities discussed herein. In this way, instructions 2216 may transform a general, non-programmed machine into a particular machine 2200 (e.g., the compute service manager 108 or a node in the execution platform 110) that is specially configured to carry out any one of the described and illustrated functions in the manner described herein. In yet another embodiment, instructions 2216 may configure the compute service manager 108 and a node in the execution platform 110 to carry out any one of the described and illustrated functions in the manner described herein.

In alternative embodiments, machine 2200 operates as a standalone device or may be coupled (e.g., networked) to other machines. In a networked deployment, machine 2200 may operate in the capacity of a server machine or a client machine in a server-client network environment or as a peer machine in a peer-to-peer (or distributed) network environment. Machine 2200 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 2216, sequentially or otherwise, that specify actions to be taken by the machine 2200. Further, while only a single machine 2200 is illustrated, the term “machine” shall also be taken to include a collection of machines 2200 that individually or jointly execute the instructions 2216 to perform any one or more of the methodologies discussed herein.

Machine 2200 includes processors 2210, memory 2230, and input/output (I/O) components 2250 configured to communicate with each other, such as via bus 2202. In some example embodiments, the processors 2210 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2212 and a processor 2214 that may execute the instructions 2216. The term “processor” is intended to include multi-core processors 2210 that may comprise two or more independent processors (sometimes referred to as “cores”) that may execute instructions 2216 contemporaneously. Although FIG. 22 shows multiple processors 2210, machine 2200 may include a single processor with a single core, a single processor with multiple cores (e.g., a multi-core processor), multiple processors with a single core, multiple processors with multiple cores, or any combination thereof.

The memory 2230 may include a main memory 2232, a static memory 2234, and a storage unit 2236, all accessible to the processors 2210, such as via the bus 2202. The main memory 2232, the static memory 2234, and the storage unit 2236 stores the instructions 2216, embodying any one or more of the methodologies or functions described herein. The instructions 2216 may also reside, wholly or partially, within the main memory 2232, within the static memory 2234, within machine storage medium 2238 of the storage unit 2236, within at least one of the processors 2210 (e.g., within the processor's cache memory), or any suitable combination thereof, during execution thereof by the machine 2200.

The I/O components 2250 include components to receive input, provide output, produce output, transmit information, exchange information, capture measurements, and so on. The specific I/O components 2250 that are included in a particular machine 2200 will depend on the type of machine. For example, portable machines such as mobile phones will likely include a touch input device or other such input mechanisms. In contrast, a headless server machine will likely not include such a touch input device. It will be appreciated that the I/O components 2250 may include many other components that are not shown in FIG. 22. The I/O components 2250 are grouped according to functionality merely to simplify the following discussion, and the grouping is in no way limiting. In various example embodiments, the I/O components 2250 may include output components 2252 and input components 2254. The output components 2252 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 2254 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures or other tactile input components), audio input components (e.g., a microphone), and the like.

Communication may be implemented using a wide variety of technologies. The I/O components 2250 may include communication components 2264, operable to couple the machine 2200 to a network 2280 or devices 2270 via a coupling 2282 and a coupling 2272, respectively. For example, communication components 2264 may include a network interface component or another suitable device to interface with network 2280. In further examples, communication components 2264 may include wired communication components, wireless communication components, cellular communication components, and other communication components to provide communication via other modalities. The device 2270 may be another machine or any of a wide variety of peripheral devices (e.g., a peripheral device coupled via a universal serial bus (USB)). For example, as noted above, machine 2200 may correspond to any one of the compute service manager 108 or the execution platform 110, and device 2270 may include the client device 114 or any other computing device described herein as being in communication with the network-based database system 102 or the storage platform 104.

The various memories (e.g., 2230, 2232, 2234, and memory of the processor(s) 2210 and the storage unit 2236) may store one or more sets of instructions 2216 and data structures (e.g., software) embodying or utilized by any one or more of the methodologies or functions described herein. These instructions 2216, when executed by the processor(s) 2210, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and media (e.g., a centralized or distributed database and associated caches and servers) that store executable instructions and data. The terms shall accordingly be taken to include, but not be limited to, solid-state memories and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 2280 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 2280 or a portion of network 2280 may include a wireless or cellular network, and coupling 2282 may be a Code Division Multiple Access (CDMA) connection, a Global System for Mobile Communications (GSM) connection, or another cellular or wireless coupling. In this example, the coupling 2282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2216 may be transmitted or received over network 2280 using a transmission medium via a network interface device (e.g., a network interface component included in the communication components 2264) and utilizing any one of several well-known transfer protocols (e.g., hypertext transfer protocol (HTTP)). Similarly, instructions 2216 may be transmitted or received using a transmission medium via coupling 2272 (e.g., a peer-to-peer coupling) to device 2270. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2216 for execution by the machine 2200 and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a method comprising: sampling, by at least one hardware processor, a table using a clustering key to obtain a set of batches, each batch of the set of batches having a set of partitions of the table; performing a clustering job for at least one batch of the set of batches; determining machine processing cost on a per-row basis, the machine processing cost associated with the clustering job for the at least one batch of the set of batches; and determining a total clustering cost associated with clustering data in the table based on the machine processing cost on the per-row basis.

In Example 2, the subject matter of Example 1 includes detecting data manipulation language (DML) commands associated with table versions of the table and grouping results of the DML commands to obtain a set of table deltas.

In Example 3, the subject matter of Example 2 includes performing a file selection of files associated with at least one table delta of the set of table deltas.

In Example 4, the subject matter of Example 3 includes determining a number of rows in the at least one table delta.

In Example 5, the subject matter of Example 4 includes determining the total clustering cost based on the number of rows in the at least one table delta and the machine processing cost on the per-row basis.

In Example 6, the subject matter of Examples 1-5 includes selecting the set of partitions in the batch based on a partition depth being higher than a clustering threshold.

In Example 7, the subject matter of Example 6 includes estimating a cost of sorting the batch using a sort operation, the estimating based on a number of rows in the set of partitions and a width of a sort key associated with the sort operation.

In Example 8, the subject matter of Example 7 includes estimating an initial cost for one-time clustering of the data in the table based on the cost of sorting the batch.

In Example 9, the subject matter of Example 8 includes determining an average change in clustering depth associated with table versions of the table, the table versions generated by data manipulation language (DML) commands; and determining maintenance cost associated with the clustering of the data in the table based on the average change in the clustering depth.

In Example 10, the subject matter of Example 9 includes, determining the total clustering cost based on the initial cost for the one-time clustering and the maintenance cost.

Example 11 is a system comprising: at least one hardware processor; and at least one memory storing instructions that cause the at least one hardware processor to perform operations comprising: sampling a table using a clustering key to obtain a set of batches, each batch of the set of batches having a set of partitions of the table; performing a clustering job for at least one batch of the set of batches; determining machine processing cost on a per-row basis, the machine processing cost associated with the clustering job for the at least one batch of the set of batches; and determining a total clustering cost associated with clustering data in the table based on the machine processing cost on the per-row basis.

In Example 12, the subject matter of Example 11 includes the operations further comprising detecting data manipulation language (DML) commands associated with table versions of the table and grouping results of the DML commands to obtain a set of table deltas.

In Example 13, the subject matter of Example 12 includes the operations further comprising performing a file selection of files associated with at least one table delta of the set of table deltas.

In Example 14, the subject matter of Example 13 includes the operations further comprising determining a number of rows in the at least one table delta.

In Example 15, the subject matter of Example 14 includes the operations further comprising determining the total clustering cost based on the number of rows in the at least one table delta and the machine processing cost on the per-row basis.

In Example 16, the subject matter of Examples 11-15 includes the operations further comprising selecting the set of partitions in the batch based on a partition depth being higher than a clustering threshold.

In Example 17, the subject matter of Example 16 includes the operations further comprising estimating a cost of sorting the batch using a sort operation, the estimating based on a number of rows in the set of partitions and a width of a sort key associated with the sort operation.

In Example 18, the subject matter of Example 17 includes the operations further comprising estimating an initial cost for one-time clustering of the data in the table based on the cost of sorting the batch.

In Example 19, the subject matter of Example 18 includes the operations further comprising determining an average change in clustering depth associated with table versions of the table, the table versions generated by data manipulation language (DML) commands, and determining maintenance cost associated with the clustering of the data in the table based on the average change in the clustering depth.

In Example 20, the subject matter of Example 19 includes the operations further comprising determining the total clustering cost based on the initial cost for the one-time clustering and the maintenance cost.

Example 21 is a computer-storage medium comprising instructions that, when executed by one or more processors of a machine, configure the machine to perform operations comprising: sampling a table using a clustering key to obtain a set of batches, each batch of the set of batches having a set of partitions of the table; performing a clustering job for at least one batch of the set of batches; determining machine processing cost on a per-row basis, the machine processing cost associated with the clustering job for the at least one batch of the set of batches; and determining a total clustering cost associated with clustering data in the table based on the machine processing cost on the per-row basis.

In Example 22, the subject matter of Example 21 includes the operations further comprising detecting data manipulation language (DML) commands associated with table versions of the table, and grouping results of the DML commands to obtain a set of table deltas.

In Example 23, the subject matter of Example 22 includes the operations further comprising performing a file selection of files associated with at least one table delta of the set of table deltas.

In Example 24, the subject matter of Example 23 includes the operations further comprising determining a number of rows in the at least one table delta.

In Example 25, the subject matter of Example 24 includes the operations further comprising determining the total clustering cost based on the number of rows in the at least one table delta and the machine processing cost on the per-row basis.

In Example 26, the subject matter of Examples 21-25 includes the operations further comprising selecting the set of partitions in the batch based on a partition depth being higher than a clustering threshold.

In Example 27, the subject matter of Example 26 includes the operations further comprising estimating a cost of sorting the batch using a sort operation, the estimating based on a number of rows in the set of partitions and a width of a sort key associated with the sort operation.

In Example 28, the subject matter of Example 27 includes the operations further comprising estimating an initial cost for one-time clustering of the data in the table based on the cost of sorting the batch.

In Example 29, the subject matter of Example 28 includes the operations further comprising determining an average change in clustering depth associated with table versions of the table, the table versions generated by data manipulation language (DML) commands; and determining maintenance cost associated with the clustering of the data in the table based on the average change in the clustering depth.

In Example 30, the subject matter of Example 29 includes the operations further comprising determining the total clustering cost based on the initial cost for the one-time clustering and the maintenance cost.

Example 31 is at least one machine-readable medium, including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not explicitly described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A method comprising:
sampling, by at least one hardware processor, a table using a clustering key to obtain a set of batches, each batch of the set of batches comprising a set of partitions of the table;
performing a clustering job for at least one batch of the set of batches;
determining a machine processing cost on a per-row basis, the machine processing cost being associated with the clustering job for the at least one batch of the set of batches; and
determining a total clustering cost associated with clustering data in the table based on the machine processing cost on the per-row basis.

2. The method of claim 1, further comprising:
detecting data manipulation language (DML) commands associated with table versions of the table; and
grouping results of the DML commands to obtain a set of table deltas.

3. The method of claim 2, further comprising:
performing a file selection of files associated with at least one table delta of the set of table deltas.

4. The method of claim 3, further comprising:
determining a number of rows in the at least one table delta.

5. The method of claim 4, further comprising:
determining the total clustering cost based on the number of rows in the at least one table delta and the machine processing cost on the per-row basis.

6. The method of claim 1, further comprising:
selecting the set of partitions in the batch based on a partition depth being higher than a clustering threshold.

7. The method of claim 6, further comprising:
estimating a cost of sorting the batch using a sort operation, the estimating based on a number of rows in the set of partitions and a width of a sort key associated with the sort operation.

8. The method of claim 7, further comprising:
estimating an initial cost for one-time clustering of the data in the table based on the cost of sorting the batch.

9. The method of claim 8, further comprising:
determining an average change in clustering depth associated with table versions of the table, the table versions generated by data manipulation language (DML) commands; and
determining a maintenance cost associated with the clustering of the data in the table based on the average change in the clustering depth.

10. The method of claim 9, further comprising:
determining the total clustering cost based on the initial cost for the one-time clustering and the maintenance cost.

11. A system comprising:
at least one hardware processor; and
at least one memory storing instructions that cause the at least one hardware processor to perform operations comprising:
sampling a table using a clustering key to obtain a set of batches, each batch of the set of batches comprising a set of partitions of the table;
performing a clustering job for at least one batch of the set of batches;
determining a machine processing cost on a per-row basis, the machine processing cost being associated with the clustering job for the at least one batch of the set of batches; and
determining a total clustering cost associated with clustering data in the table based on the machine processing cost on the per-row basis.

12. The system of claim 11, the operations further comprising:
detecting data manipulation language (DML) commands associated with table versions of the table; and
grouping results of the DML commands to obtain a set of table deltas.

13. The system of claim 12, the operations further comprising:
performing a file selection of files associated with at least one table delta of the set of table deltas.

14. The system of claim 13, the operations further comprising:
determining a number of rows in the at least one table delta.

15. The system of claim 14, the operations further comprising:
determining the total clustering cost based on the number of rows in the at least one table delta and the machine processing cost on the per-row basis.

16. The system of claim 11, the operations further comprising:
selecting the set of partitions in the batch based on a partition depth being higher than a clustering threshold.

17. The system of claim 16, the operations further comprising:
estimating a cost of sorting the batch using a sort operation, the estimating based on a number of rows in the set of partitions and a width of a sort key associated with the sort operation.

18. The system of claim 17, the operations further comprising:
estimating an initial cost for one-time clustering of the data in the table based on the cost of sorting the batch.

19. The system of claim 18, the operations further comprising:
determining an average change in clustering depth associated with table versions of the table, the table versions generated by data manipulation language (DML) commands; and
determining a maintenance cost associated with the clustering of the data in the table based on the average change in the clustering depth.

20. The system of claim 19, the operations further comprising:
determining the total clustering cost based on the initial cost for the one-time clustering and the maintenance cost.

21. A computer-storage medium comprising instructions that, when executed by one or more processors of a machine, configure the machine to perform operations comprising:
sampling a table using a clustering key to obtain a set of batches, each batch of the set of batches comprising a set of partitions of the table;
performing a clustering job for at least one batch of the set of batches;
determining a machine processing cost on a per-row basis, the machine processing cost being associated with the clustering job for the at least one batch of the set of batches; and
determining a total clustering cost associated with clustering data in the table based on the machine processing cost on the per-row basis.

22. The computer-storage medium of claim 21, the operations further comprising:
detecting data manipulation language (DML) commands associated with table versions of the table; and
grouping results of the DML commands to obtain a set of table deltas.

23. The computer-storage medium of claim 22, the operations further comprising:
performing a file selection of files associated with at least one table delta of the set of table deltas.

24. The computer-storage medium of claim 23, the operations further comprising:
determining a number of rows in the at least one table delta.

25. The computer-storage medium of claim 24, the operations further comprising:
determining the total clustering cost based on the number of rows in the at least one table delta and the machine processing cost on the per-row basis.

26. The computer-storage medium of claim 21, the operations further comprising:
selecting the set of partitions in the batch based on a partition depth being higher than a clustering threshold.

27. The computer-storage medium of claim 26, the operations further comprising:
estimating a cost of sorting the batch using a sort operation, the estimating based on a number of rows in the set of partitions and a width of a sort key associated with the sort operation.

28. The computer-storage medium of claim 27, the operations further comprising:
estimating an initial cost for one-time clustering of the data in the table based on the cost of sorting the batch.

29. The computer-storage medium of claim 28, the operations further comprising:
determining an average change in clustering depth associated with table versions of the table, the table versions generated by data manipulation language (DML) commands; and
determining a maintenance cost associated with the clustering of the data in the table based on the average change in the clustering depth.

30. The computer-storage medium of claim 29, the operations further comprising:
determining the total clustering cost based on the initial cost for the one-time clustering and the maintenance cost.
